(19) United States
(12) Patent Application Publication
(10) Pub. No.: US 2025/0041826 A1
(43) Pub. Date: Feb. 6, 2025

(54) BASES FOR LOW-TEMPERATURE CARBON DIOXIDE CAPTURE AND RELEASE

(71) Applicants: International Business Machines Corporation, Armonk, NY (US); The Trustees of Columbia University in the City of New York, New York, NY (US)

(72) Inventors: Luis M. Campos, New York, NY (US); Dino Wu, New York, NY (US); James L. Hedrick, Pleasanton, CA (US); Nathaniel H. Park, San Jose, CA (US); Junho Kwon, Bronx, NY (US)

(21) Appl. No.: 18/364,678

(22) Filed: Aug. 3, 2023

(51) Int. Cl. B01J 20/26; B01D 53/04; B01J 20/28; B01J 20/32

(52) U.S. Cl. CPC B01J 20/26; B01D 53/0462; B01J 20/28047; B01J 20/3204; B01D 2253/202; B01D 2257/504

(57) ABSTRACT

Processes, compositions, and apparatus are disclosed. A first process includes providing a cyclopropenimine (CPI). A second process includes providing 1,8-diazabicyclo[5.4.0]undec-7-ene (DBU). The first and second processes include reacting the CPI and DBU, respectively, with carbon dioxide (CO₂) in the presence of a nucleophilic species (NuH) and releasing CO₂ from products of the reactions by heating to a temperature below about 120° C. A process of direct air capture includes obtaining atmospheric CO₂, reacting the CO₂ with an organic base having an imine moiety to form a NuCO₂⁻ salt, and heating the NuCO₂⁻ salt to a temperature below about 120° C. A composition for low-temperature CO₂ release includes a tris(amino)cyclopropenium (TAC⁺) ion and NuCO₂⁻. An apparatus includes a component configured to provide a composition, including a CPI, for capturing CO₂ and a component configured to release the CO₂ by heating a to a temperature below 120° C.

### BACKGROUND

The present disclosure relates to materials for carbon dioxide (CO₂) capture and release and, more specifically, to superbasic compounds for capture and release of CO₂ under mild conditions.

Techniques for capturing atmospheric CO₂ (e.g., direct-air-capture (DAC)) can be used to offset CO₂ emissions. Current DAC technologies generally involve sorption materials, which can absorb CO₂ gas at atmospheric levels and then desorb the gas as an isolated stream in specified intervals. Techniques for transferring and chemically transforming CO₂ can be used to produce synthetically useful compounds. For example, captured CO₂ may be used as a feedstock in the synthesis of polymeric materials. Upcycling CO₂ into useful monomers may also facilitate a shift in production away from standard, fossil fuel intensive approaches that employ highly toxic chemicals, such as phosgene. However, challenges exist in that many processes for DAC, CO₂ reduction/upcycling, CO₂ storage, etc., can have energy requirements (e.g., heating for CO₂ release) that reduce their practicality. Therefore, techniques that allow CO₂ capture/release at lower temperatures may be needed.

### SUMMARY

Various embodiments are directed to a process that includes providing a cyclopropenimine (CPI) having the following structure:

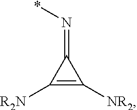

Wherein each R is an organic substituent, and wherein the starred bond is to a carbon atom. For example, the modular compound can include CPIs with the following structures:

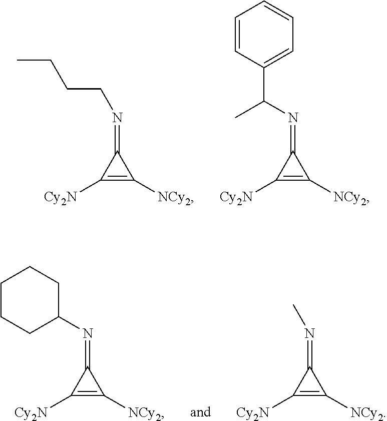

Additionally, the CPI may be a pendent group linked to a polymer backbone selected from polynorbornenes, polyurethanes, polymethacrylates, polymethylmethacrylates, polystyrenes, polyesters, polyamines, polyethers, epoxide resins, and polycarbonates. In some embodiments, when the CPI is a pendent group on a polymer, and the nucleophilic species is a crosslinker, the product of the reaction may be a gel. Additionally, the CPI may be a surface functionality on a silica material such as mesoporous silica particles. The process also includes reacting the CPI with CO₂ in the presence of a nucleophilic species (NuH). In some embodiments, the NuH is selected from water, piperidine, aniline, and n-butylamine. Further, the process includes releasing the CO₂ from a product of the reaction by heating the product to a temperature below about 120° C. For example, the CO₂ may be released by heating the product to 30-50° C., 40-70° C., 50-80° C., 70-90° C., or 80-110 C. In some embodiments, the product has the following structure:

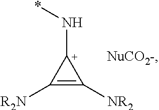

wherein Nu is a radical species selected from the group consisting of hydroxyl, a primary amine, and secondary amine, the starred bond is to a carbon atom, and each R is an organic substituent.

Further embodiments are direct to a process that includes providing 1,8-diazabicyclo[5.4.0]undec-7-ene (DBU), reacting the DBU with CO₂ in the presence of a nucleophilic species (NuH), and releasing the CO₂ from a product of the reaction by heating the product to a temperature below about 120° C. For example, the CO₂ may be released by heating the product to 30-50° C., 40-70° C., 50-80° C., 70-90° C., or 80-110 C. In some embodiments, the NuH is selected from water, piperidine, aniline, and n-butylamine.

Additional embodiments are directed to a process of direct air capture (DAC), which includes obtaining atmospheric CO₂, reacting the CO₂ with an organic base having an imine moiety in the presence of a nucleophilic species NuH. The process can also include obtaining a NuCO₂⁻ salt formed in the reaction and heating the NuCO₂⁻ salt to a temperature below about 120° C. The process can also include collecting CO₂ released by the heating. The organic base may be a cyclopropenimine (CPI) or 1,8-diazabicyclo[5.4.0]undec-7-ene (DBU). The reacting can include mixing a material containing the organic base (e.g., a solid-state CPI, a CPI solution, a polymer with CPI pendent groups, and silica with CPI surface functionalities) with the CO₂. In some embodiments, the NuH is selected from water, piperidine, aniline, and n-butylamine.

Further embodiments are directed to a composition for low-temperature CO₂ release. The composition includes a tris(amino)cyclopropenium (TAC⁺) salt having the following structure:

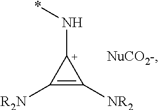

wherein Nu is a radical species selected from the group consisting of hydroxyl, a primary amine, and secondary amine, each R is an organic substituent, and the starred bond is to a carbon atom. The CO₂ is released from the composition at temperatures between about 30° C. and 120° C. In some embodiments, the release of the CO₂ generates a compound having the following structure:

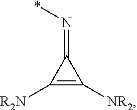

wherein each R is an organic substituent, and wherein the starred bond is to a carbon atom.

Additional embodiments are directed to an apparatus that includes a first component configured to provide a composition for capturing CO₂. The composition includes a CPI. The apparatus also includes a second component configured to release the CO₂ from a product of a reaction between the CPI, CO₂, and a nucleophilic species NuH by heating the product below about 120 C. In some embodiments, the composition comprises a solid polymer resin or a mesoporous silica surface-functionalized with the CPI. In some embodiments, the CO₂ is captured from air.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A is a chemical reaction diagram illustrating a process of reversible, cyclopropenimine (CPI)-facilitated carbon dioxide (CO₂) capture, according to some embodiments.

FIG. 1B is a chemical reaction diagram illustrating a process of reversible, 1,8-diazabicyclo(5.4.0)undec-7-ene (DBU)-facilitated CO₂ capture, according to some embodiments.

FIG. 2A is a chemical structure diagram illustrating CPIs a-g that may be used to reversibly capture CO₂, according to some embodiments.

FIG. 2B is a chemical structure diagram illustrating tris(amino)cyclopropenium (TAC⁺) ions a-g that may be formed by reacting the CPIs illustrated in FIG. 2A with CO₂ and a nucleophilic species NuH, according to some embodiments.

FIG. 3A is a chemical structure diagram illustrating a set of TAC⁺ a/NuCO₂⁻ species, according to some embodiments.

FIG. 3B is a chemical structure diagram illustrating a set of TAC⁺ b/NuCO₂⁻ species, according to some embodiments.

FIG. 3C is a chemical structure diagram illustrating a set of TAC⁺ c/NuCO₂⁻ species, according to some embodiments.

FIG. 3D is a chemical structure diagram illustrating a set of TAC⁺ d/NuCO₂⁻ salts, according to some embodiments.

FIG. 4A is a proton nuclear magnetic resonance (H¹-NMR) spectrum of CPI a (FIG. 2A).

FIG. 4B is an infrared (IR) spectrum of a [TAC]⁺[HCO₃]⁻ salt (TAC⁺ a/NuCO₂⁻, where Nu=OH) obtained by reacting the CPI a of FIG. 4A with CO₂ in the presence of H₂O.

FIG. 4C is a ¹³C-NMR spectrum of the [TAC⁺][HCO₃⁻] salt obtained in the reaction discussed with respect to FIG. 4B.

FIG. 5A is a ¹NMR spectrum of a polymer with [TAC]⁺[HCO₃]⁻ pendent groups obtained by reacting CPI e with CO₂ in the presence of H₂O.

FIG. 5B is a C¹³-NMR spectrum of the polymer with [TAC]⁺[HCO₃]⁻ pendent groups obtained by reacting CPI e with CO₂ in the presence of H₂O.

FIG. 6 is a set of TGAs measuring CO₂ released at several different temperatures from TAC⁺ a/HCO₃⁻.

FIG. 7 is an Arrhenius plot generated for the release of CO₂ from TAC⁺ a/HCO₃⁻.

FIG. 8A is a TGA measuring decomposition of carboxylate from TAC⁺ a/HCO₃⁻.

FIG. 8B is a TGA measuring decomposition of carboxylate from TAC⁺ b/HCO₃⁻.

FIG. 9A is a set of TGA measuring CO₂ released from TAC⁺ a/HCO₃⁻, TAC⁺ b/HCO₃—, and TAC⁺ c/HCO₃⁻.

FIG. 9B is a TGA measuring CO₂ released from DBU-H⁺/HCO₃⁻.

FIG. 9C is a TGA measuring CO₂ released from TAC⁺ e/HCO₃⁻.

FIG. 10 is a set of TGA measuring CO₂ released from TAC⁺ a/NuCO₂⁻ salts illustrated in FIG. 3A.

FIGS. 11A-11D are sets of TGA measuring CO₂ released from TAC⁺ a-d/NuCO₂⁻ salts illustrated in FIGS. 3A-3D.

FIG. 12A is a chemical reaction diagram illustrating reversible CO₂ and H₂O capture by a solid-state CPI, according to some embodiments.

FIG. 12B is a TGA measuring solid-state adsorption of CO₂ during an experimental example of the reaction shown in FIG. 12A.

FIGS. 13A and 13B illustrate chemical reaction diagrams and corresponding TGAs and measuring percent CO₂ released during experimental examples of the illustrated reactions.

FIG. 14A is a chemical reaction diagram illustrating a process of CO₂ capture by a polynorbornene homopolymer (CPI e) with CPI pendent groups, according to some embodiments.

FIG. 14B is a photograph illustrating a gel formed in an experimental example of the reaction illustrated in FIG. 14A.

FIG. 15 is a chemical reaction diagram illustrating a process of forming TAC⁺-functionalized mesoporous silica particles, according to some embodiments.

FIGS. 16A and 16B are TGA measuring CO₂ release from the CPI-functionalized mesoporous silica particles.

FIGS. 17A and 17B are sets of TGA-mass spectra measuring CO₂ and H₂O release from the CPI-functionalized mesoporous silica particles.

FIGS. 18A-18C are sets of chemical structure diagrams illustrating additional CPIs that may be used to reversibly capture CO₂, according to some embodiments.

FIG. 19 is flowchart illustrating a process of reversible CO₂ capture and release, according to some embodiments.

While the invention is amenable to various modifications and alternative forms, specifics thereof have been shown by way of example in the drawings, and will be described in detail. It should be understood, however, that the intention is not to limit the invention to the particular embodiments described. Instead, the intention is to cover all modifications, equivalents, and alternatives falling within the spirit and scope of the invention.

### DETAILED DESCRIPTION

Embodiments of the present invention are generally directed to direct-air-capture (DAC) of carbon dioxide (CO₂) and, more specifically, to cyclopropenimine compounds for capturing and transferring CO₂. While the present disclosure is not necessarily limited to such applications, various aspects of the disclosure may be appreciated through a discussion of examples using this context.

Techniques for reducing atmospheric CO₂ are essential for the goal of limiting the global temperature rise to 1.5° C. by 2050. Current emissions at 35 gigatonnes per year (Gt/yr) are expected to rise to ˜40-45 Gt/yr by 2050. Point source capture, zero-emission technologies, such as renewables for energy production, and reduced-emission programs are expected to lower emissions (e.g., by about 800-900 Mt/yr). However, these efforts cannot offset CO₂ from long distance travel/cargo transport and certain heavy industries (expected to account for 15+% emissions annually), nor can they remove already-emitted CO₂ from the atmosphere.

Negative emissions using DAC may overcome these challenges. Current DAC technologies generally involve sorption materials, which can absorb CO₂ gas at atmospheric levels and then desorb the gas as an isolated stream in specified intervals. Another advantage of DAC is that captured CO₂ may be used as a feedstock in the synthesis of polymeric materials. Upcycling CO₂ into useful monomers would also facilitate a shift in production away from standard, fossil fuel intensive approaches that employ highly toxic chemicals, such as phosgene. However, challenges remain in scaling DAC sufficiently. For example, current atmospheric loading of CO₂ is a dilute 415 ppm, but the estimated total carbon load in the atmosphere is 900+Gt. Developing, refining, and scaling DAC to ensure economic viability and carbon neutrality will require new, highly efficient chemical transformations. Embodiments of the present disclosure may be used to overcome these challenges.

Disclosed herein are cyclopropenimine (CPI)-based molecules and polymers that may be used for upcycling and capture/release of CO₂. In the presence of nucleophilic species (NuH), e.g., water, amines, or alcohols, various NuCO₂⁻/TAC⁺ (tris[amino]cyclopropenium) salts can be formed. The reverse process, resulting in CO₂ release, can be carried out at low temperatures. For example, the disclosed CPI compounds can be used to reversibly convert CO₂ into bicarbonate (HCO₃⁻) in the presence of water. Herein, “low temperature” and “mild heating” refer to temperatures below about 150° C. unless stated otherwise. For example, CO₂ may be released by heating the TAC⁺/NuCO₂⁻ salts to temperatures between about 30° C. and 120° C., depending upon the CPI/NuH used (e.g., about 30-50° C., 40-70° C., 50-80° C., 70-90° C., 80-110 C, etc.).

The disclosed CPIs can be superbasic (e.g., having conjugate acids with pK_{BH+}˜27-28) due to aromatic stabilization from the cyclopropenium ion. The disclosed CPIs can form adducts with CO₂ (CPI-CO₂ adducts) and “activate” CO₂ for subsequent chemical transformations. In some embodiments, low-energy CO₂ release from CPI-CO₂ adducts can be accomplished with external stimuli (e.g., mechano- or photochemical activation). Additionally, the disclosed materials may be synthesized on a large scale from readily available, inexpensive substrates and processed into emulsions, membranes, particles, etc. that may be integrated within CO₂ reactors. Such materials may enable DAC systems that operate at ambient conditions using localized, renewable energy sources.

Various embodiments are directed to a process that includes providing a cyclopropenimine (CPI) having the following structure:

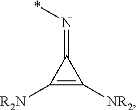

wherein each R is an organic substituent, and wherein the starred bond is to a carbon atom. This compound has advantageous properties including its reactivity with CO₂ and its modularity. For example, the modular compound can include CPIs with the following structures:

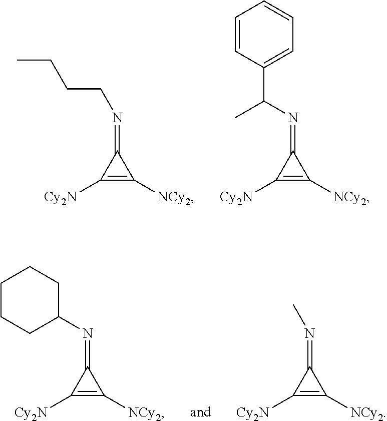

Additionally, the CPI may be a pendent group linked to a polymer backbone selected from polynorbornenes, polyurethanes, polymethacrylates, polymethylmethacrylates, polystyrenes, polyesters, polyamines, polyethers, epoxide resins, and polycarbonates. In some embodiments, when the CPI is a pendent group on a polymer, and the nucleophilic species is a crosslinker, the product of the reaction may be a gel. Additionally, the CPI may be a surface functionality on a silica material such as mesoporous silica particles. The ability to form a variety of materials with the CPI may allow the CPI to be incorporated into numerous useful applications. The process also includes reacting the CPI with CO₂ in the presence of a nucleophilic species (NuH). In some embodiments, the NuH is selected from water, piperidine, aniline, and n-butylamine. These nucleophilic species may be advantageous because of their reactivity with the CPI and CO₂, as well as because they are commonly available. Further, the process includes releasing the CO₂ from a product of the reaction by heating the product to a temperature below about 120° C. An advantage of these operations is that they can enable CO₂ capture/release from CPIs without requiring impractical amounts of energy to release the CO₂. For example, the CO₂ may be released by heating the product to 30-50° C., 40-70° C., 50-80° C., 70-90° C., or 80-110 C. In some embodiments, the product has the following structure:

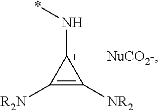

wherein Nu is a radical species selected from the group consisting of hydroxyl, a primary amine, and secondary amine, the starred bond is to a carbon atom, and each R is an organic substituent. Advantageous properties of this product can include its ability to store the captured CO₂ until the temperature is raised.

Further embodiments are directed to a process that includes providing 1,8-diazabicyclo[5.4.0]undec-7-ene (DBU), reacting the DBU with CO₂ in the presence of a nucleophilic species (NuH), and releasing the CO₂ from a product of the reaction by heating the product to a temperature below about 120° C. An advantage of this process is that it can enable CO₂ capture/release from DBU, which reacts well with CO₂, without requiring impractical amounts of energy to release the CO₂. For example, the CO₂ may be released by heating the product to 30-50° C., 40-70° C., 50-80° C., 70-90° C., or 80-110 C. In some embodiments, the NuH is selected from water, piperidine, aniline, and n-butylamine. These nucleophilic species may be advantageous because of their reactivity with the DBU and CO₂, as well as because they are commonly available.

Additional embodiments are directed to a process of direct air capture (DAC), which includes obtaining atmospheric CO₂, reacting the CO₂ with an organic base having an imine moiety in the presence of a nucleophilic species NuH. The process can also include obtaining a NuCO₂⁻ salt formed in the reaction and heating the NuCO₂⁻ salt to a temperature below about 120° C. The process can also include collecting CO₂ released by the heating. The DAC process may advantageously allow removal of atmospheric CO₂ with lower energy requirements than traditional DAC. The organic base may be a cyclopropenimine (CPI) or 1,8-diazabicyclo[5.4.0]undec-7-ene (DBU). The reacting can include mixing a material containing the organic base (e.g., a solid-state CPI, a CPI solution, a polymer with CPI pendent groups, and silica with CPI surface functionalities), with the CO₂. The organic bases have advantageous properties including their reactivity with CO₂ and their modularity, and incorporating them into various materials can allow a variety of techniques for DAC to be carried out. In some embodiments, the NuH is selected from water, piperidine, aniline, and n-butylamine. These nucleophilic species may be advantageous because of their reactivity with the DBU and CO₂, as well as because they are commonly available.

Further embodiments are directed to a composition for low-temperature CO₂ release. The composition includes a tris(amino)cyclopropenium (TAC⁺) salt having the following structure:

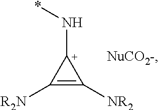

wherein Nu is a radical species selected from the group consisting of hydroxyl, a primary amine, and secondary amine, each R is an organic substituent, and the starred bond is to a carbon atom. The CO₂ is released from the composition at temperatures between about 30° C. and 120° C. In some embodiments, the release of the CO₂ generates a compound having the following structure:

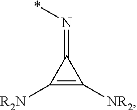

wherein each R is an organic substituent, and wherein the starred bond is to a carbon atom. This compound may advantageously used to capture CO₂ in one or more cycles of CO₂ capture and release.

Additional embodiments are directed to an apparatus that includes a first component configured to provide a composition for capturing CO₂. The composition includes a CPI. The apparatus also includes a second component configured to release the CO₂ from a product of a reaction between the CPI, CO₂, and a nucleophilic species NuH by heating the product below about 120° C. The apparatus may advantageously enable low-temperature CO₂ capture and release. In some embodiments, the composition comprises a solid polymer resin or a mesoporous silica surface-functionalized with the CPI. Using materials such as these may allow various types of apparatus to be used for capturing CO₂. In some embodiments, the CO₂ is captured from air. This may enable reduction of atmospheric CO₂.

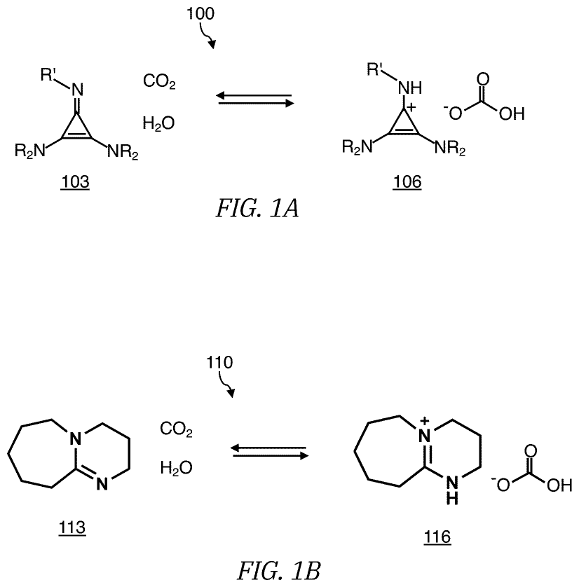

Referring now to the drawings, in which like numerals represent the same or similar elements, FIG. 1A is a chemical reaction diagram illustrating a reversible process 100 of CPI-facilitated CO₂ capture, according to some embodiments. On the illustrated CPI 103, R and R′ are organic moieties (e.g., methyl, butyl, cyclohexyl, phenyl, etc.). When CPI 103 reacts with CO₂, a CPI-CO₂ adduct (not shown) is formed. The CPI-CO₂ adduct is a zwitterion characterized by an aromatic cyclopropenium (tris(amino)cyclopropenium, or TAC⁺) ion, which can be stabilized by the electron-donating amine substituents, and an anionic carbonate moiety. The CO₂ capture of process 100 may be carried out at temperatures of about 20-30° C., or cooler, in the presence of water or another nucleophilic species (see below). The temperature used may be selected based on the CPI. When water is present in the reaction with CO₂, as shown in FIG. 1A, a bicarbonate (HCO₃⁻) salt of the TAC⁺ ion 106 forms.

FIG. 1B is a chemical reaction diagram illustrating a reversible process 110 of 1,8-diazabicyclo(5.4.0)undec-7-ene (DBU)-facilitated CO₂ capture, according to some embodiments. Process 110 may be carried out under ambient conditions with DBU 113 in the presence of water or another nucleophilic species, such as those discussed with respect to the CPI. When water is present in the reaction with CO₂, as shown in FIG. 1B, a bicarbonate salt of H-DBU⁺ forms 116.

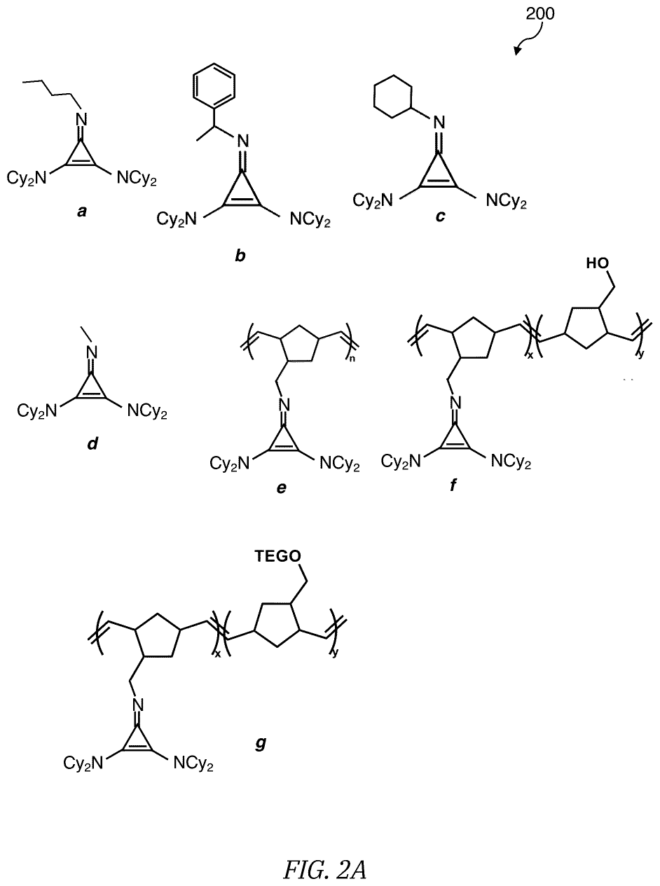

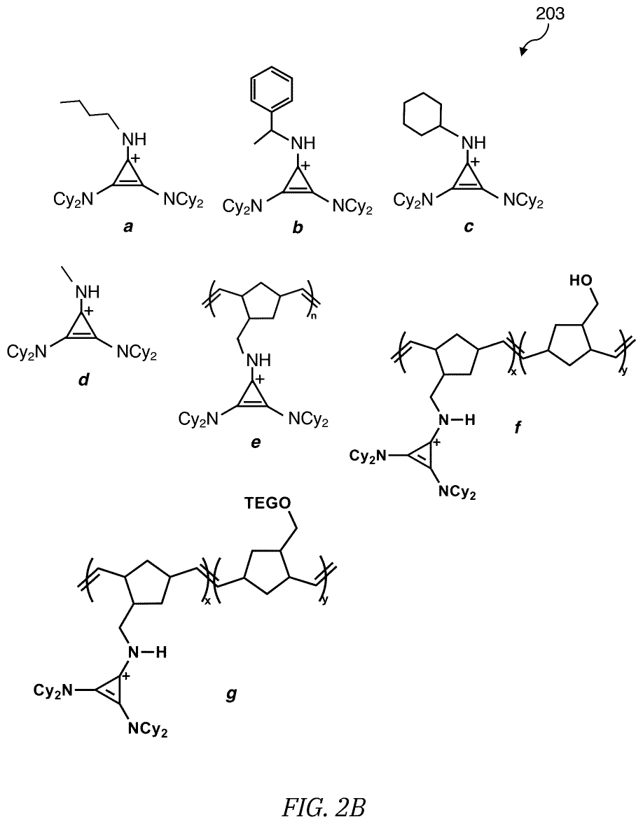

FIG. 2A is a chemical structure diagram 200 illustrating CPIs a-g that may be used to reversibly capture CO₂, according to some embodiments. CPIs a-g are examples of CPI 103 illustrated in FIG. 1A, where R=cyclohexyl ligands and R′ is n-butyl (CPI a), 1-phenylethyl (CPI b), cyclohexyl (CPI c), methyl (CPI d), or a methylene moiety bound to a polymer backbone (CPIs e, f, and g).

CPIs e-g have polynorbornene backbones with CPI pendent groups. The term “backbone” as used herein refers to the portion of a polymer that is a continuous chain. The terms “side chain” and “pendent group” refer to portions of the polymer that append from the backbone. CPI e is a homopolymer with CPI pendent groups on each repeat unit n (where n is an integer greater than 1). CPIs f and g are polynorbornene statistical copolymers with x CPI pendent groups and y triethyleneglycol (TEGO-) or hydroxyl (HO—) pendent groups, respectively (where x and y are integers greater than 1). In these embodiments, the length of the polymer backbone is not critical and is readily determined and/or modified according to the end use of the linear polymer. Thus n, x, and y may, independently, be any positive integer. For example, n may vary between 1-1,000,000, such as 1-500,000, or 1-250,000, or 1-100,000, or 1-50,000, or 1-25,000, or 1-10,000, or 1-1,000, or 1-500, or 1-250, or 1-100, or 1-50, or 1-25, or 1-10, or 1-5.

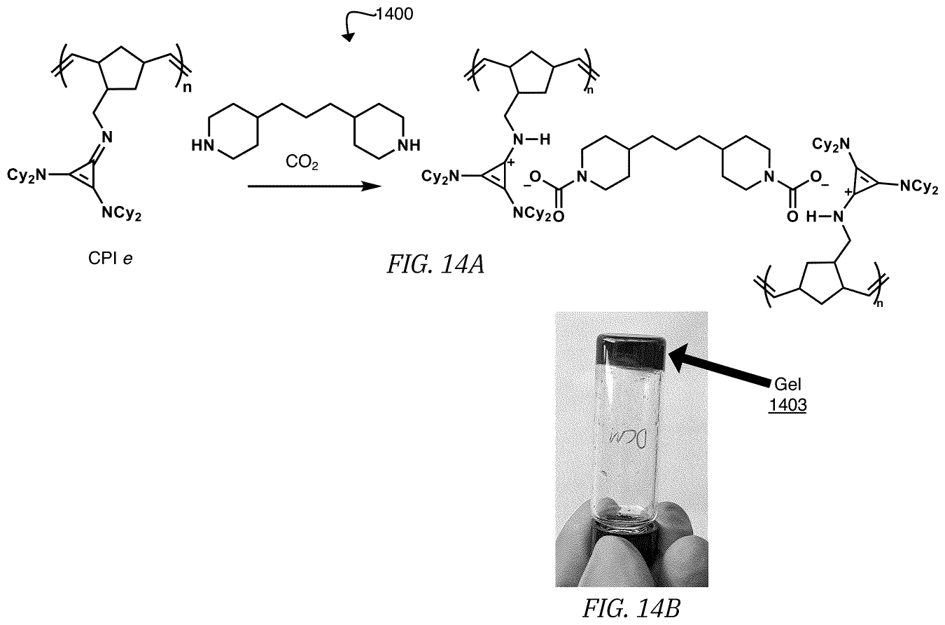

CPIs (e.g., CPIs a-g illustrated in FIG. 2A) can be formed using any appropriate techniques. The ability to vary R and R′ groups based on secondary and primary amine selection provides modularity to the CPI core by allowing tuning of parameters such as reactivity, solubility, etc. In some embodiments, CPI synthesis includes reacting tetrachlorocyclopropene with a secondary amine R₂NH (e.g., dicyclohexylamine (DHA), where R=Cy) in dichloromethane (DCM). The resulting diamine CPI chloride salt (see, e.g., FIG. 14) can be reacted with a primary amine R′—NH₂ to form a CPI conjugate acid (CPI-H⁺) chloride salt. Basification of CPI-H⁺ yields the CPI.

In other embodiments, CPIs can be formed in a DCM-free process. In these instances, pentachlorocyclopropane can be dissolved in a first solvent (e.g., ethyl acetate), the second solvent may be chloroform, and the third solvent may be toluene. The secondary amine R₂NH can be added to the solution. The resulting precipitated products, including a CPI-chloride salt and a secondary amine salt, can be added to a second solvent (e.g., chloroform). This can result in a mixture containing the secondary amine salt precipitate dispersed in a chloroform solution of the CPI chloride salt. The CPI-chloride salt can be extracted from the mixture and dissolved with a primary amine (R′NH₃) in a third solvent (e.g., toluene). The CPI chloride salt can react with the primary amine to form a TAC+ salt. The TAC+ salt may be polymerized in some embodiments (e.g., CPIs e-g). The TAC+ salt can be neutralized in an alkaline solution (e.g., an aqueous solution of about 1 mol/Liter (M) sodium carbonate (Na₂CO₃), about 1-2 M potassium carbonate (K₂CO₃), about 20-30% by volume (vol. %) ammonium hydroxide (NH₄OH), about 1 M sodium hydroxide (NaOH), etc.) to generate the CPI.

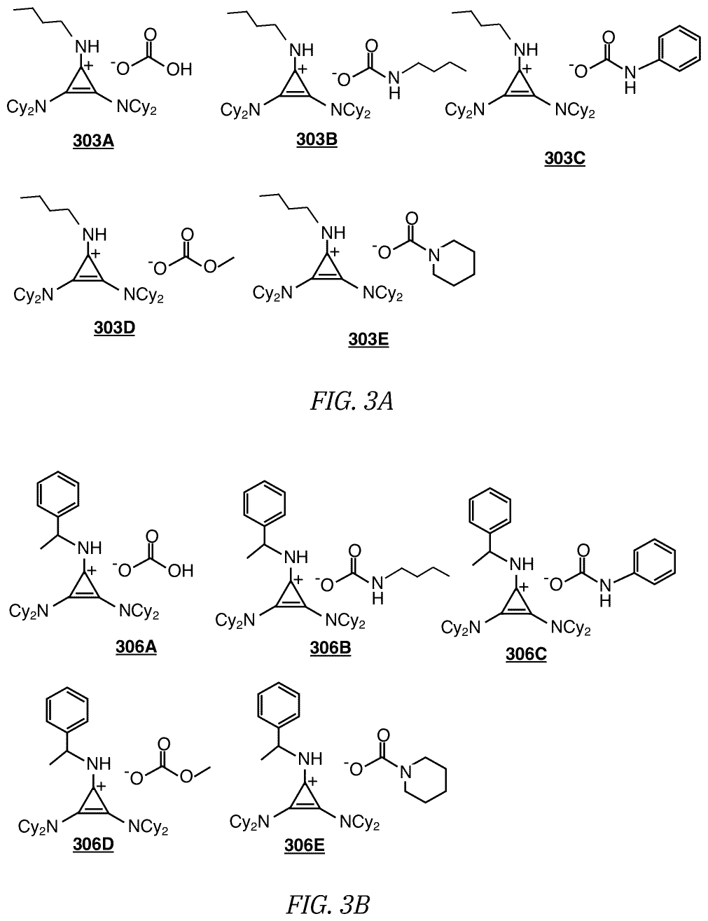

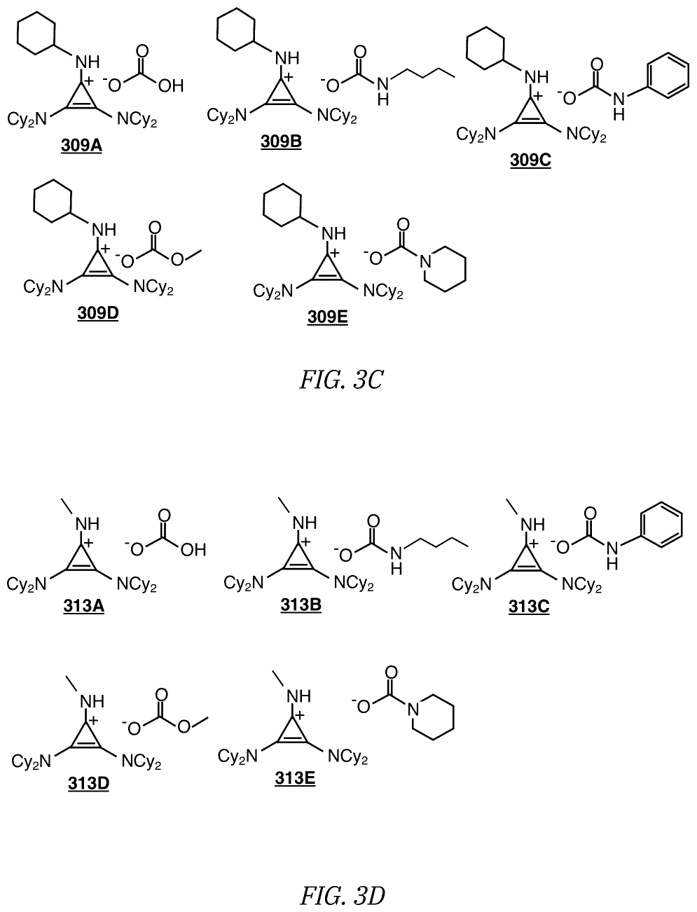

FIG. 2B is a chemical structure diagram illustrating tris(amino)cyclopropenium (TAC⁺) species a-g that may be formed by reacting the CPIs illustrated in FIG. 2A (respectively, CPIs a-g) with CO₂ and a nucleophilic species NuH (not shown in FIG. 2B), according to some embodiments. The reaction reversibly captures CO₂, resulting in a TAC⁺/NuCO₂⁻ salt ([TAC]⁺[NuCO₂]⁻). For example, as illustrated in FIG. 1A, the nucleophilic species NuH may be water (Nu=OH). In these instances, TAC⁺ a-g bicarbonate (HCO₃⁻) salts are formed. Other nucleophilic species are illustrated in FIGS. 3A-3D, although any appropriate nucleophilic species may be used in some embodiments.

FIG. 3A is a chemical structure diagram illustrating a set of TAC⁺ a/NuCO₂⁻ salts 303A-303D (collectively TAC⁺ a/NuCO₂⁻ 303), according to some embodiments. The salts TAC⁺ a/NuCO₂⁻ 303, can be formed by reacting CPI a with CO₂ and NuH, where NuH is water (TAC⁺ a/NuCO₂⁻ 303A), n-butylamine (TAC⁺ a/NuCO₂⁻ 303B), aniline (TAC⁺ a/NuCO₂⁻ 303C), methanol (TAC⁺ a/NuCO₂⁻ 303D), or piperidine (TAC⁺ a/NuCO₂⁻ 303E).

FIG. 3B is a chemical structure diagram illustrating a set of TAC⁺ b/NuCO₂⁻ salts 306A-306D (collectively TAC⁺ b/NuCO₂⁻ 306), according to some embodiments. The illustrated salts TAC⁺ b/NuCO₂⁻ 306, can be formed by reacting CPI b with CO₂ and NuH, where NuH is water (TAC⁺ b/NuCO₂⁻ 306A), n-butylamine (TAC⁺ b/NuCO₂⁻ 306B), aniline (TAC⁺ b/NuCO₂⁻ 306C), methanol (TAC⁺ b/NuCO₂⁻ 306D), or piperidine (TAC⁺ b/NuCO₂⁻ 306E).

FIG. 3C is a chemical structure diagram illustrating a set of TAC⁺ c/NuCO₂⁻ salts 309A-309D (collectively TAC⁺ c/NuCO₂⁻ 309), according to some embodiments. The illustrated salts TAC⁺ c/NuCO₂⁻ 309, can be formed by reacting CPI c with CO₂ and NuH, where NuH is water (TAC⁺ c/NuCO₂⁻ 309A), n-butylamine (TAC⁺ c/NuCO₂⁻ 309B), aniline (TAC⁺ c/NuCO₂⁻ 309C), methanol (TAC⁺ c/NuCO₂⁻ 309D), or piperidine (TAC⁺ c/NuCO₂⁻ 309E).

FIG. 3D is a chemical structure diagram illustrating a set of TAC⁺ d/NuCO₂⁻ salts 313A-313D (collectively TAC⁺ d/NuCO₂⁻ 313), according to some embodiments. The illustrated salts TAC⁺ d/NuCO₂⁻ 313, can be formed by reacting CPI d with CO₂ and NuH, where NuH is water (TAC⁺ d/NuCO₂⁻ 313A), n-butylamine (TAC⁺ d/NuCO₂⁻ 313B), aniline (TAC⁺ d/NuCO₂⁻ 313C), methanol (TAC⁺ d/NuCO₂⁻ 313D), or piperidine (TAC⁺ d/NuCO₂⁻ 313E).

In addition to the illustrated examples of TAC⁺/NuCO₂⁻ salts 303-313, analogous salts can be made by reacting NuH with CPIs a-g illustrated in FIG. 2A or other appropriate CPIs. In further embodiments, NuH species including, but not limited to, water, n-butylamine, aniline, methanol, piperidine, etc. may be reacted with DBU to form various DBU-H⁺/NuCO₂⁻ salts.

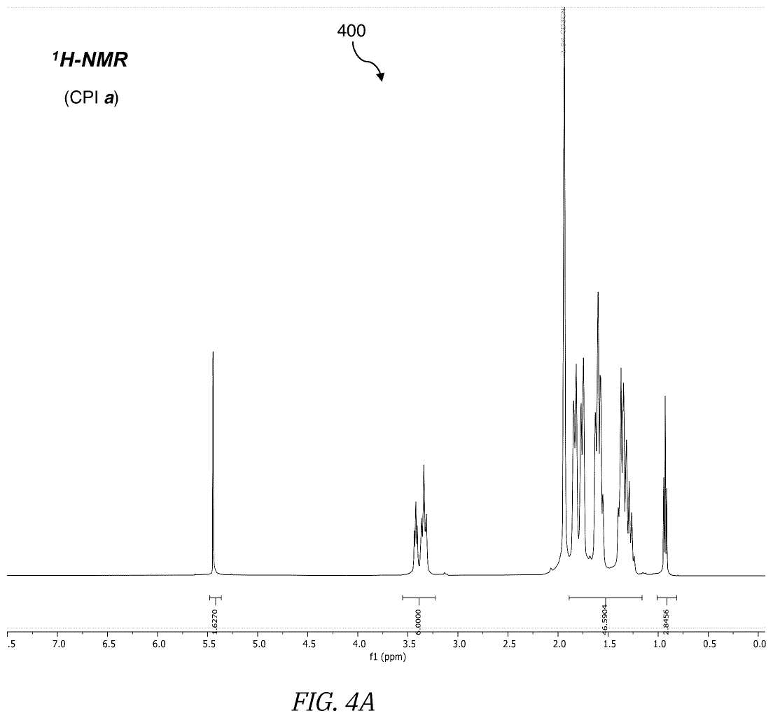

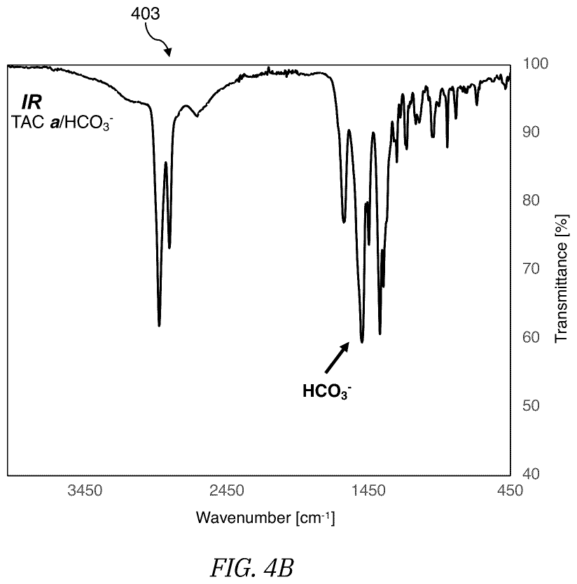

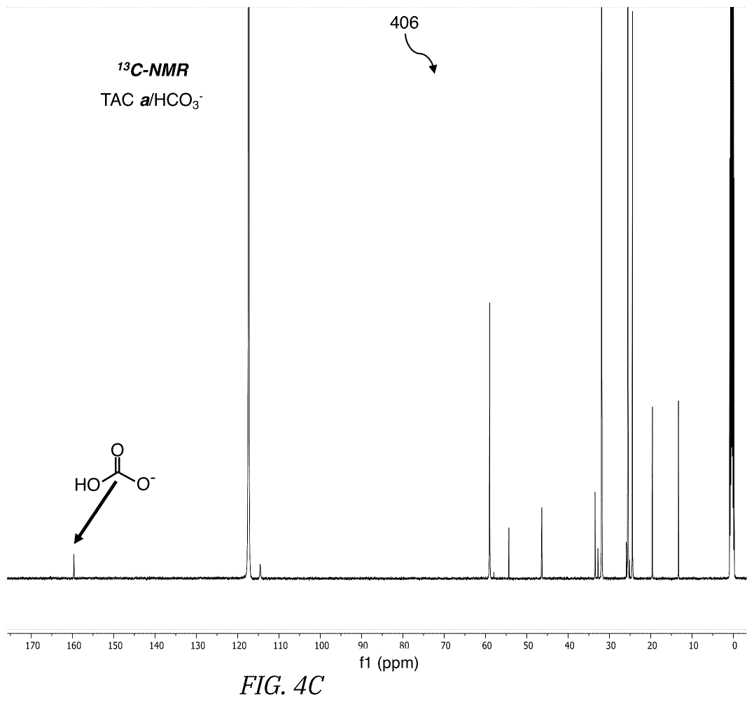

FIG. 4A is a proton nuclear magnetic resonance (¹H-NMR) spectrum 400 of CPI a (FIG. 2A). CPI a was formed by reacting tetrachlorocyclopropene with DHA in a DCM solution. The product of this reaction was reacted with n-butylamine to form a CPI conjugate acid (CPI-H⁺) chloride salt. Basification of CPI-H⁺ by rinsing with a sodium hydroxide solution yielded CPI a. The ¹H-NMR spectrum 400 was obtained in deuterated DCM.

FIG. 4B is an infrared (IR) spectrum 403 of a [TAC]⁺[HCO₃]⁻ salt (TAC⁺ a/NuCO₂⁻ 303A, where Nu=OH) obtained by reacting the CPI a of FIG. 4A with CO₂ in the presence of H₂O. The water sources included atmospheric water vapor and condensate (e.g., when dry ice was used as a source of CO₂). In this reaction, CPI a was dissolved in DCM, and CO₂ was bubbled into the solution until the DCM had evaporated. The IR spectrum 403 of the isolated product shows characteristic bicarbonate (HCO₃⁻) stretching indicated by the arrow in FIG. 4B.

FIG. 4C is a ¹³C-NMR spectrum 406 of the TAC⁺ a/HCO₃⁻ obtained in the reaction discussed with respect to FIG. 4B. Like the IR spectrum 403, the ¹³C-NMR 406 shows the bicarbonate formed in the reaction between CPI a and CO₂ in the presence of water. Based on the NMR spectrum 406, it was determined that the reaction resulted in a quantitative yield of TAC⁺ a/HCO₃⁻ 303A in the organic solvent (DCM).

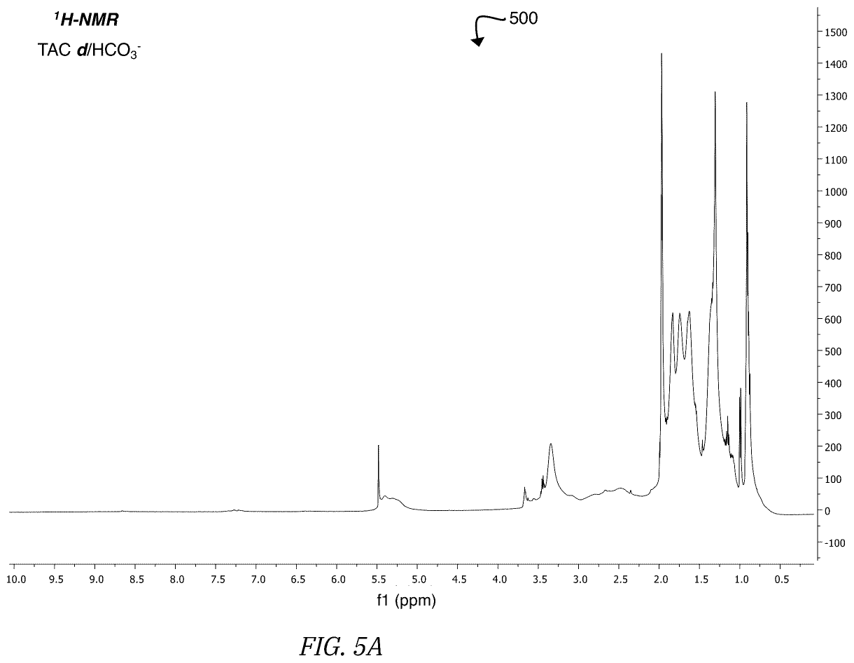

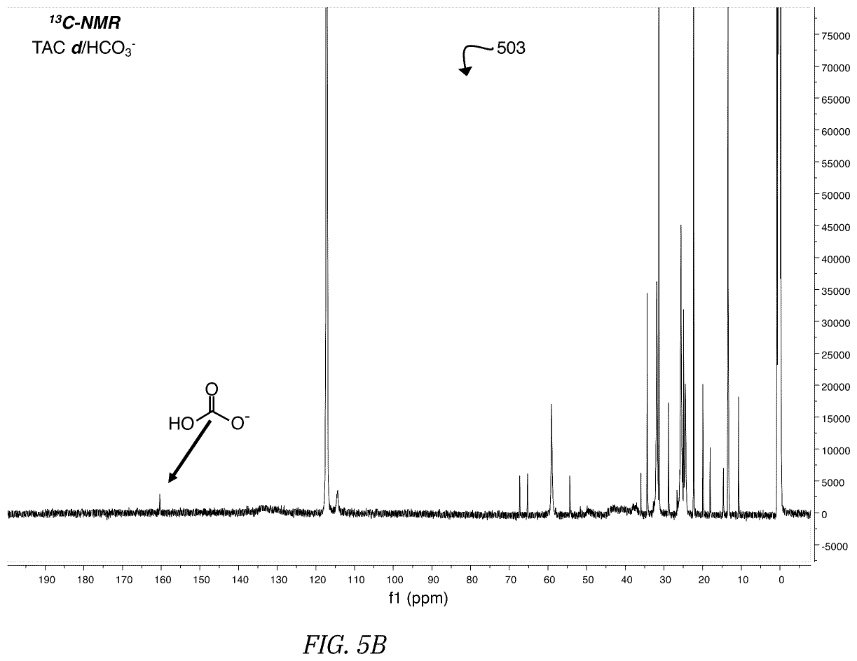

FIG. 5A is a ¹H-NMR spectrum 500 of a polymer with [TAC]⁺[HCO₃]⁻ pendent groups obtained by reacting CPI e (FIG. 2A) with CO₂ (in DCM) in the presence of H₂O. FIG. 5B is a ¹³C-NMR spectrum 503 of this polymer, showing the carbon of HCO₃⁻. These NMR spectra 500 and 503 were used to determine that the TAC⁺ e/HCO₃⁻ salt formed quantitatively.

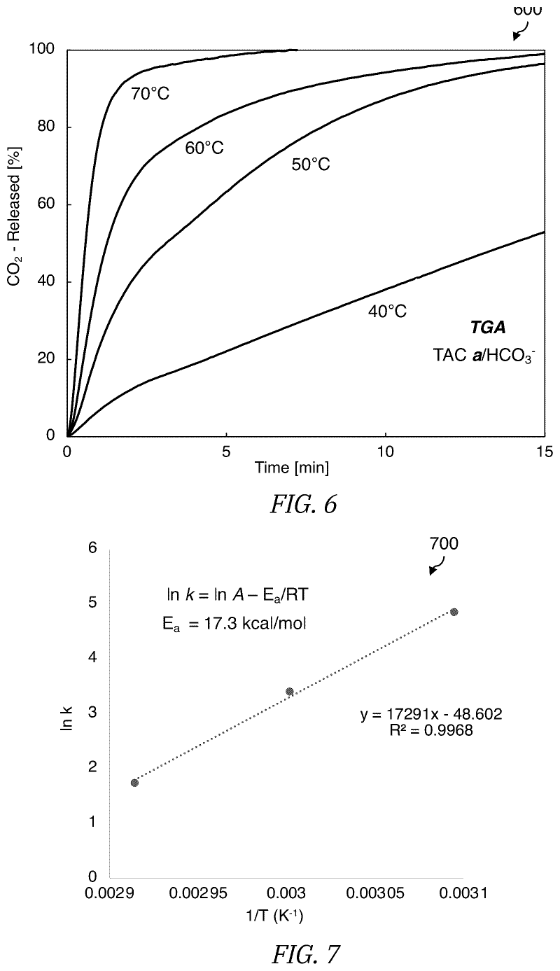

FIG. 6 is a set of TGAs 600 measuring CO₂ released at several different temperatures from TAC⁺ a/HCO₃⁻ 303A (FIG. 3A). Release of CO₂ was measured at 40° C., 50° C., 60° C., and 70 C, for 15 minutes at each temperature. As shown in FIG. 6, CO₂ was released at each temperature, and the speed/efficiency of CO₂ release increased with temperature.

FIG. 7 is an Arrhenius plot 700 generated for the release of CO₂ from TAC⁺ a/HCO₃⁻. The plot was used to determine the rate constant Eₐ (17.3 kcal/mol) for the reaction.

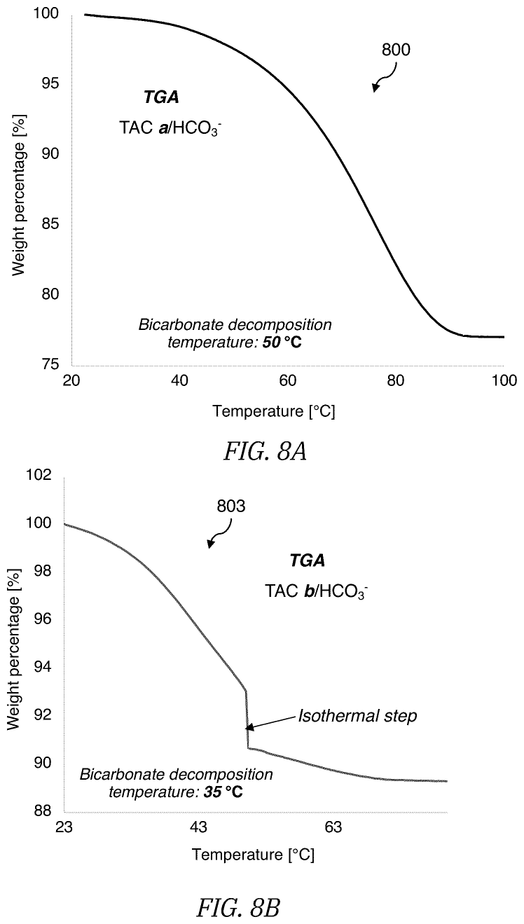

FIG. 8A is a TGA 800 measuring decomposition of carboxylate from TAC⁺ a/HCO₃⁻ 303A (FIG. 3A). The weight percent (wt. %) decreased as CO₂ was released upon raising the temperature of the TAC⁺ a/HCO₃⁻ 303A from room temperature to 100° C. The decomposition temperature of the bicarbonate in TAC⁺ a/HCO₃⁻ 303A was found to be about 50° C.

FIG. 8B is a TGA 803 measuring decomposition of carboxylate from TAC⁺ b/HCO₃⁻ 306A (FIG. 3B). The weight percent decreased as CO₂ was released upon raising the temperature of the TAC⁺ b/HCO₃⁻ 306A sample from room temperature to about 100° C. The decomposition temperature of the bicarbonate in TAC⁺ b/HCO₃⁻ 306A was found to be about 35° C.

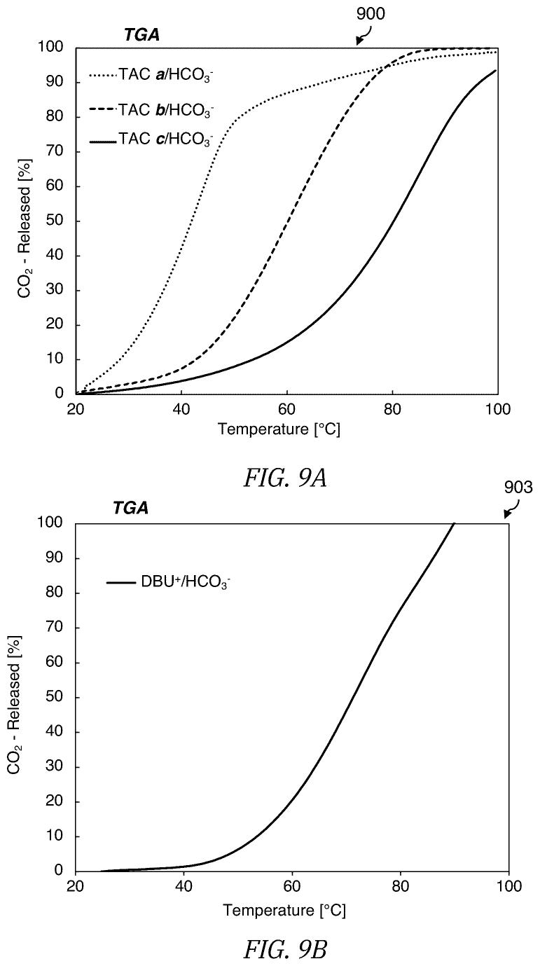

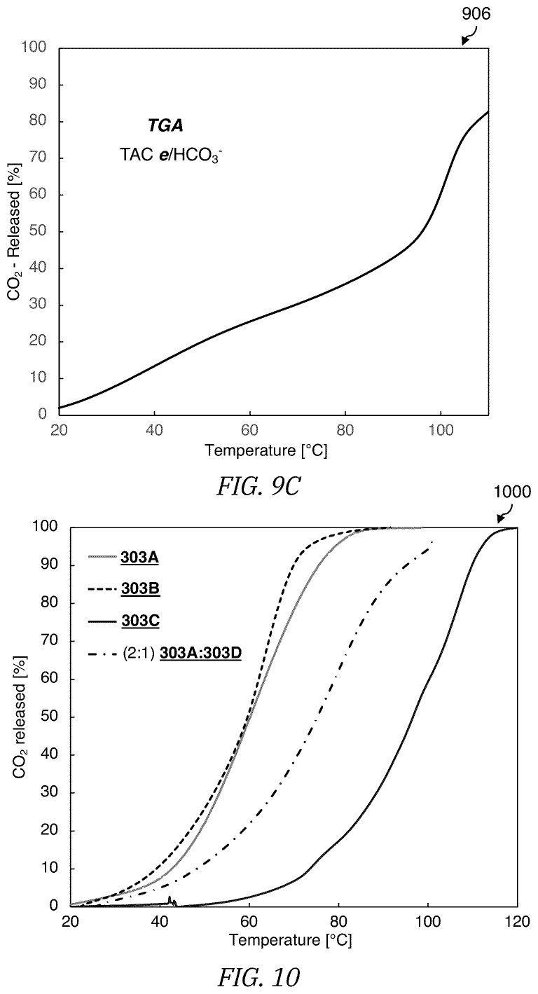

FIG. 9A is a set of TGA 900 measuring CO₂ released from TAC⁺ a/HCO₃⁻ 303A, TAC⁺ b/HCO₃⁻ 306A, and TAC⁺ c/HCO₃⁻ 309A. FIG. 9B is a TGA 903 measuring CO₂ released from DBU-H⁺/HCO₃⁻ 116 (FIG. 1B). FIG. 9C is a TGA 906 measuring CO₂ released from TAC⁺ e/HCO₃. In each experiment illustrated in FIGS. 9A-9C, the percent CO₂ released from TACs a-c and e/HCO₃⁻ and DBU-H⁺/HCO₃⁻ was measured while increasing the temperature from room temperature to about 100-110° C. FIGS. 9A-9C illustrate how, in some embodiments, CO₂ release temperature can be varied by changing the R′ group on the TAC⁺/CPI species.

FIG. 10 is a set of TGA 1000 measuring CO₂ released from TAC⁺ a/NuCO₂⁻ 303A, 303B, 303C, and a 2:1 mixture of 303A:303D (FIG. 3A). In each experiment illustrated in FIG. 10, the percent CO₂ released from TAC⁺ a/NuCO₂⁻ 303A-303D was measured while increasing the temperature from room temperature to about 120° C. FIG. 10 illustrates how, in some embodiments, CO₂ release temperature of TAC⁺ a/NuCO₂⁻ (where R′=n-butyl) can be varied by changing the nucleophilic species (Nu).

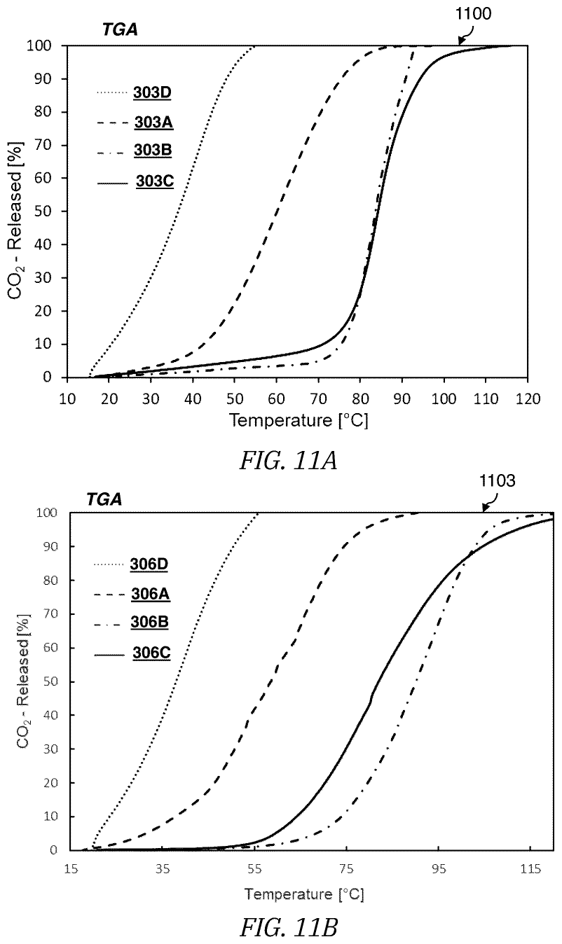

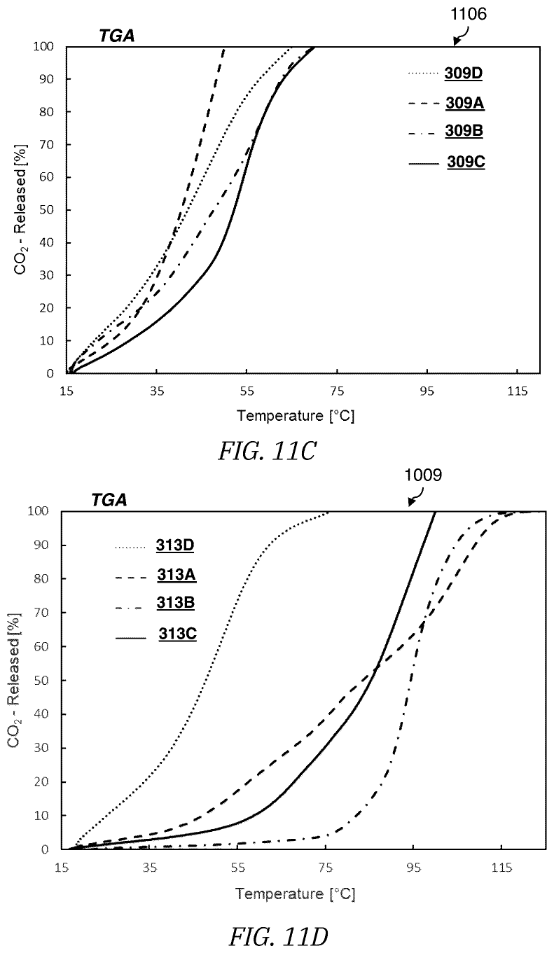

FIGS. 11A-11D are sets of TGA 1100-1109 measuring CO₂ released from TACs a-d/NuCO₂⁻ 303A-313D illustrated in FIGS. 3A-3D. FIG. 11A is a set of TGA 1100 measuring CO₂ released from TAC⁺ a/NuCO₂⁻ 303A-303D (FIG. 3A). FIG. 11B is a set of TGA 1103 measuring CO₂ released from TAC⁺ b/NuCO₂⁻ 306A-306D (FIG. 3B). FIG. 11C is a set of TGA 1106 measuring CO₂ released from TAC⁺ c/NuCO₂⁻ 309A-309D (FIG. 3C). FIG. 11D is a set of TGA 1109 measuring CO₂ released from TAC⁺ d/NuCO₂⁻ 313A-313D (FIG. 3D).

In the experiments illustrated in FIGS. 11B-11D, the percent CO₂ released from TACs a-d/NuCO₂⁻ was measured while heating from a starting temperature between about 15-25° C. to a final temperature of about 120° C. FIGS. 11B-11D further illustrate how, in some embodiments, CO₂ release temperature can be varied by changing the nucleophilic species and/or R′ ligand.

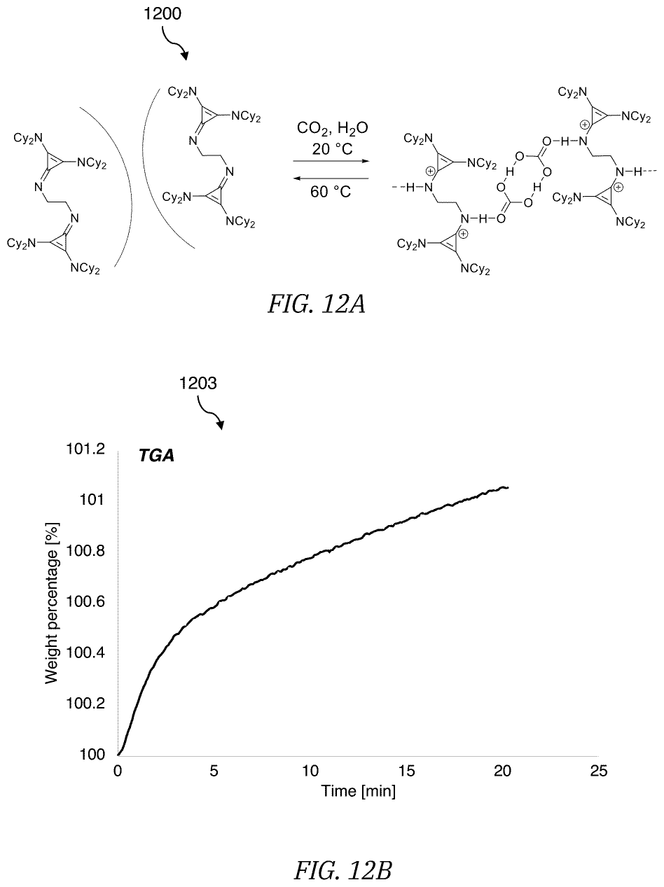

FIG. 12A is a chemical reaction diagram 1200 illustrating reversible CO₂ and H₂O capture by a solid-state CPI, according to some embodiments. In this reaction, the CPI captures CO₂ in the presence of water to form solid-state TAC⁺/HCO₃⁻ species. FIG. 12B is a TGA 1203 measuring solid-state adsorption of CO₂ during an experimental example of the reaction 1200 shown in FIG. 12A. The CPI shown in FIG. 12A is reacted with CO₂ in the presence of H₂O at about 20° C. About 10% of maximal CO₂ adsorption by the CPI was observed within about 20 minutes.

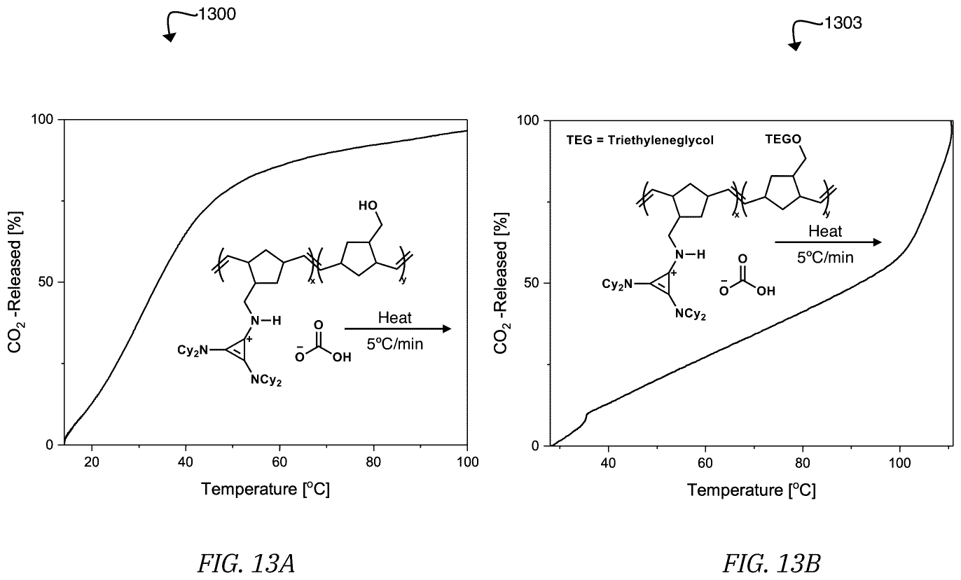

FIGS. 13A and 13B illustrate chemical reaction diagrams and corresponding TGAs 1300 and 1303 measuring percent CO₂ released during experimental examples of the illustrated reactions. In FIG. 13A, CO₂ was released while heating TAC⁺ f/HCO₃⁻ from about 0° C. to about 100° C. at a rate of 5° C./minute (min). In FIG. 13B, CO₂ was released while heating TAC⁺ g/HCO₃⁻ from about 0° C. to about 120° C. at a rate of 5° C./min.

FIG. 14A is a chemical reaction diagram 1400 illustrating a process of CO₂ capture by a polynorbornene homopolymer (CPI e) with CPI pendent groups, according to some embodiments. The nucleophilic species in this reaction is 1,3-bis(4-piperidyl)propane. When CO₂ reacts with CPI e and a crosslinking nucleophilic species “bis(NuH)”, as illustrated in FIG. 14A, a gel can form. FIG. 14B is a photograph illustrating a gel 1403 formed in an experimental example of the reaction 1400 illustrated in FIG. 14A. In this example, a DCM solution of CPI e (200 mg/mL) and the bis(NuH) crosslinker 1,3-bis(4-piperidyl)propane was prepared with a CPI:bis(NuH) ratio of 100:30. Bubbling CO₂ into the solution resulted in the gel 1403.

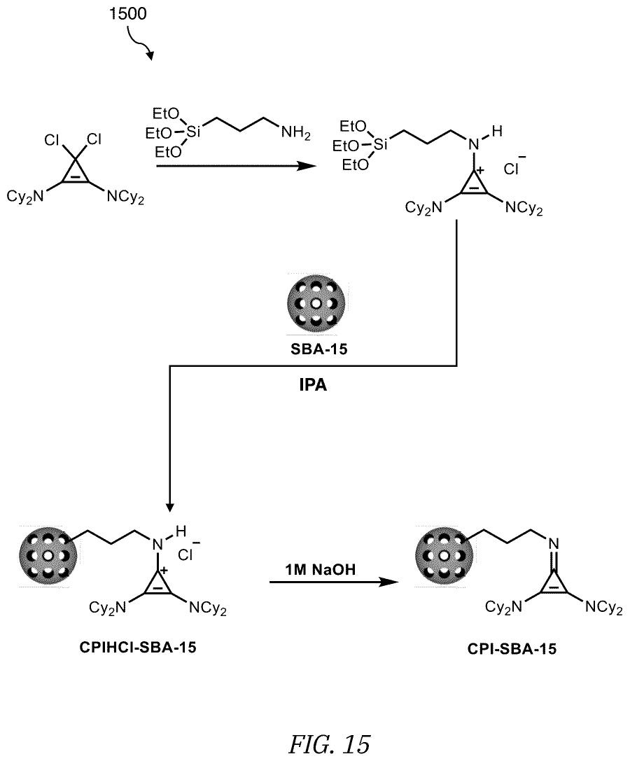

FIG. 15 is a chemical reaction diagram 1500 illustrating a process of forming CPI-functionalized mesoporous silica particles, according to some embodiments. Various techniques may be used to form silica with CPI functionalities. For example, CPIs with R′ groups containing organosilicon moieties may be formed in reactions such as those discussed above with respect to FIG. 1A. In the illustrated reaction 1500, a CPI chloride salt is reacted with a primary amine R′NH₂ where R′ includes a triethoxysilane moiety, resulting in a triethoxysilane-functionalized TAC⁺/Cl⁻ species. In some embodiments, this reaction is carried out at about 70° C. with a 1:1 ratio of water:CPI chloride salt and a 0.1:1 ratio of oxalic acid:CPI chloride salt.

Mesoporous silica is then provided and surface-functionalized with the TAC⁺ species (e.g., in a solvent such as isopropyl alcohol). In the illustrated reaction 1500, the mesoporous silica is SBA-15 (Santa Barbara Amorphous-15) mesoporous silica particles. However, any appropriate silica particles/materials may be used in other embodiments. Basification (e.g., rinsing with a 1 M NaOH solution) of the TAC⁺ functionalities then provides CPI-functionalized porous silica particles.

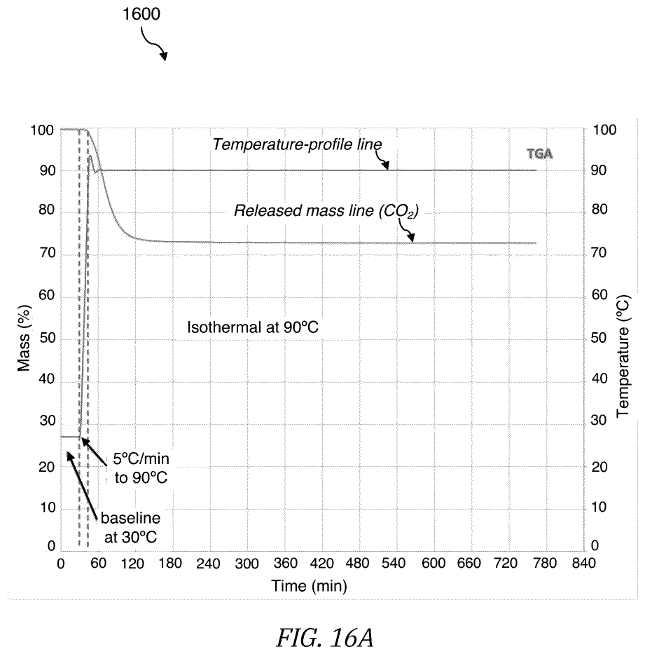

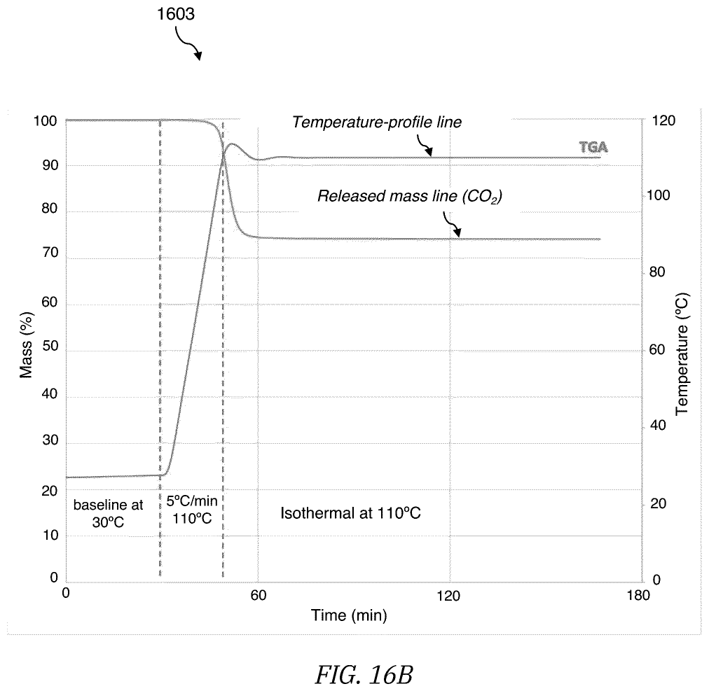

FIGS. 16A and 16B are TGA 1600 and 1603, respectively, measuring CO₂ release (“released mass line”) from the CPI-functionalized porous silica particles illustrated in FIG. 15. On each graph 1600 and 1603, the lefthand y-axis represents the mass percent of the samples, and the righthand y-axis axis represents the temperature function of the TGA instrument. The “temperature profile line” indicates the information input into the TGA instrument, including the heating ramp (5° C./min.), baseline temperature (30° C.), and isothermal temperature (90° C. in TGA 1600 and 110° C. in TGA 1603). The “mass loss line” indicates the mass loss while heating, corresponding to release of CO₂ from the functionalized mesoporous silica.

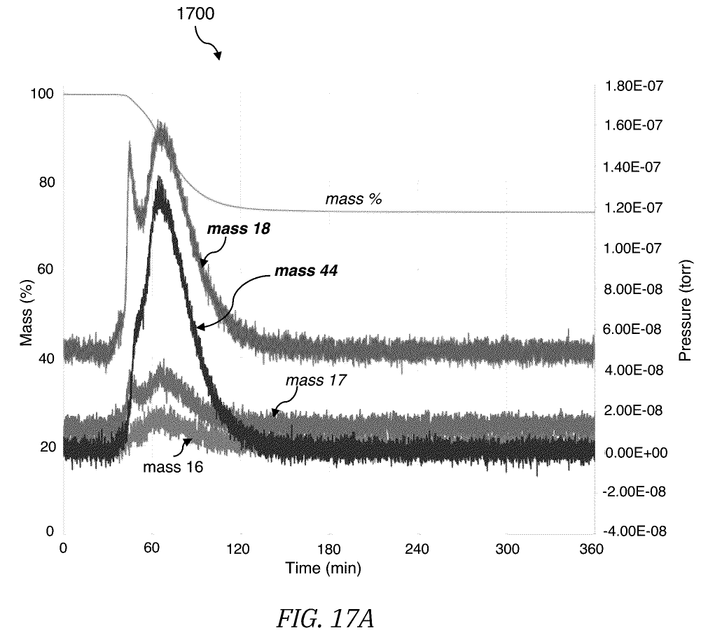

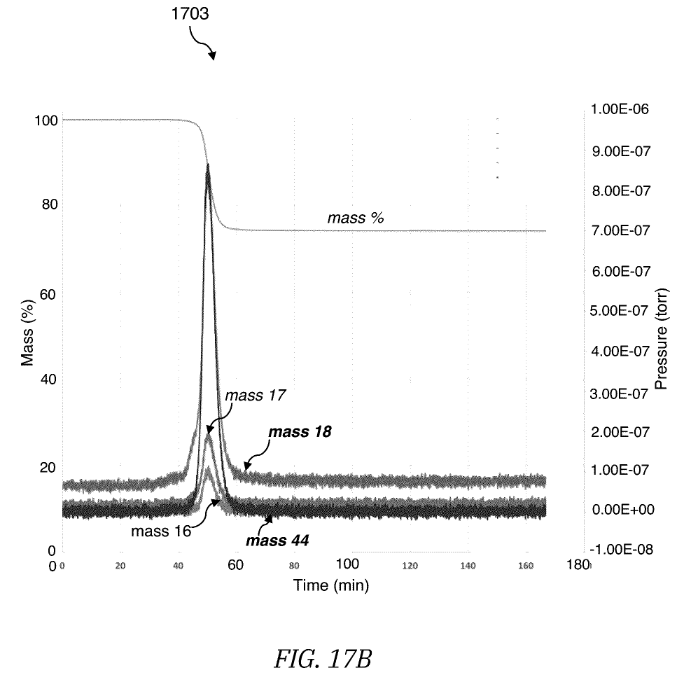

FIGS. 17A and 17B are sets of TGA-mass spectra (TGA-MS) 1700 and 1703, respectively, measuring CO₂ and H₂O release from CPI-functionalized porous silica particles. Each spectrum shows the mass % of the samples, which decreases upon loss of CO₂ and H₂O. The additional lines correspond to concentrations of gaseous species (measured in Torr) in the samples and are labeled with the molecular masses of the species (16, 17, 18, and 44). The largest peaks are “mass 18” (molecular mass H₂O=18.02 g/mol) and “mass 44” (molecular mass CO₂=44.01 g/mol). The TGA-MS 1700 and 1703 each show loss of peaks corresponding to CO₂ and H₂O over the course of the experiment.

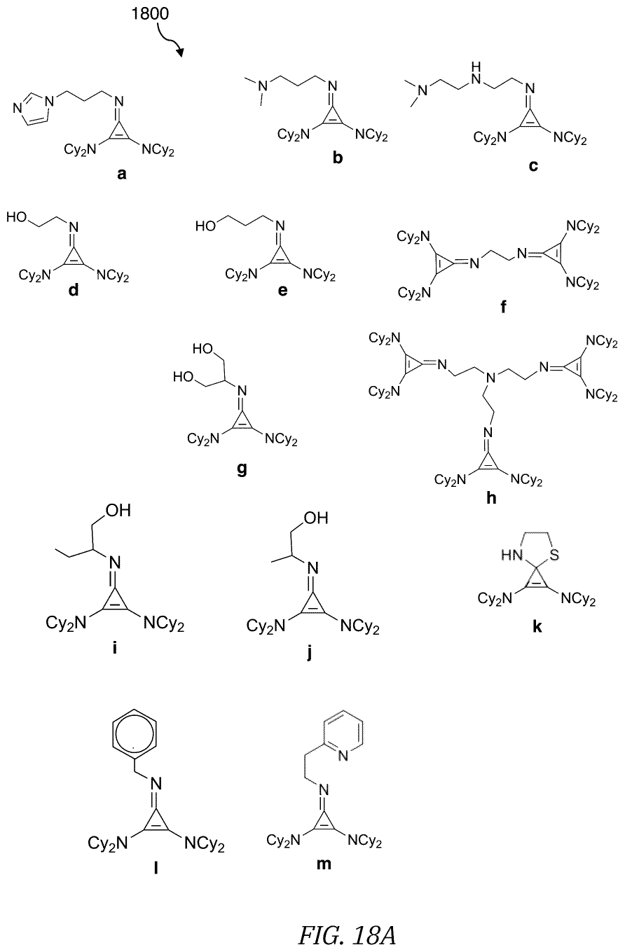

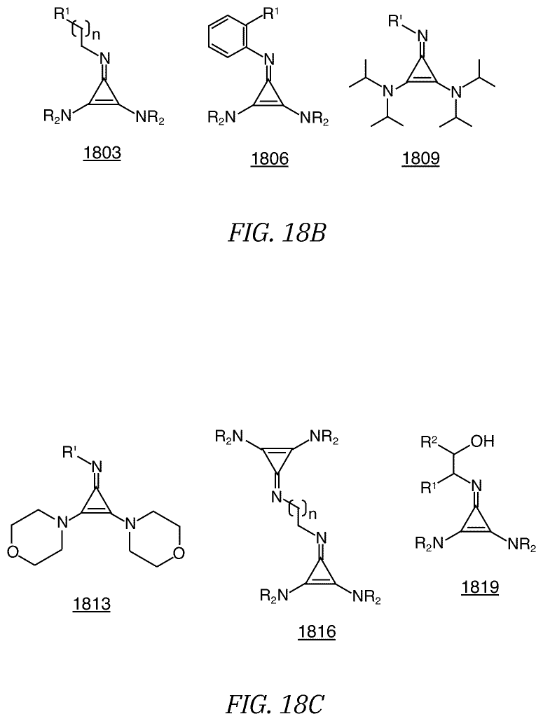

FIGS. 18A-18C are sets of chemical structure diagrams illustrating additional CPIs that may be used to reversibly capture CO₂, according to some embodiments. FIG. 18A illustrates a set 1800 of CPIs a-m with dicyclohexyl R groups. These CPIs a-m may be formed in synthetic processes such as those discussed above, using DHA as the secondary amine. In other embodiments, the R groups may be varied by replacing DHA with other secondary amines. To vary the R′ groups of CPIs a-m, the primary amines used in the synthesis are:
1-(3-aminopropyl)imidazole (a),
N,N-dimethyl-1,3-propandiamine (b),
N,N-dimethyldiethylenetriamine (c),
2-aminoethanol (d),
2-amino-1-propanol (e),
1,2-diaminoethane (f),
2-aminopropane-1,3-diol (g),
tris(2-aminoethyl)amine (h),
2-amino-1-butanol (i),
2-amino-1-propanol (j),
2-aminoethanethiol (k),
benzylamine (l), and
2-pyridylethylamine (m).

FIG. 18B illustrates structures 1803-1809 of CPIs with a series of R groups, according to some embodiments. The R groups can be modified to tune solubility, basicity, stability, etc. For example, CPI 1803, which has morpholino R groups, may be more soluble than CPI 1806 or CPI 1809, which have isopropyl and cyclohexyl R groups, respectively. Further, the R groups may be modified to induce twisting of the plane between the cyclopropene ring and the —NR₂ moieties due to steric interactions. This may impact the basicity and reactivity of the CPIs. The R′ group of CPIs 1803-1809 can be any appropriate organic substituent (see, e.g., FIGS. 2A, 15, 18A, and 18C).

FIG. 18C illustrates additional examples of CPIs 1813-1819. The R′ groups of CPI 1813 and CPI 1816, respectively, include linear alkyl and cyclic aromatic moieties. The R′ group of CPI 1819 includes an alcohol moiety. In CPIs 1813-1819, R¹ and R² can, independently, be hydrogen atoms or any appropriate reactive or unreactive functional groups. The R′ groups can be modified to tune interactions with CO₂. For example, when R′ includes an alcohol moiety (e.g., CPI 1819 or CPIs 1813/1816 when R¹ has a hydroxyl moiety), a synergistic effect on CO₂ capture analogous to alcohol-containing guanidine and amidine systems may be conferred. The R groups of CPIs 1813-1819 can be any appropriate organic substituents (see, e.g., FIGS. 2A, 18A, and 18B).

In addition to the polynorbornenes illustrated in FIG. 2A, further embodiments (not shown) can include a variety of polymers containing CPI and/or tris[amino]cyclopropenium (TAC⁺) pendent groups. Examples of homo- and copolymers that may be synthesized with these pendent groups can include, but are not limited to polyurethanes, polycarbonates, polystyrenes, polymethylmethacrylates, polymethacrylates, polyethers, polyesters, epoxide resins, polyamines, etc. These polymers can be formed using polymerizable building blocks including TAC⁺ or CPIs (“TAC⁺/CPIs”) with polymerizable R and/or R′ groups. In other embodiments, TAC⁺/CPI pendent groups may be added post-polymerization.

In some embodiments, polymers with TAC⁺/CPI pendent groups can be formed as solid-phase resins that may be incorporated into continuous capture and transformation processes. For example, crosslinking agents can be used to form various TAC⁺/CPI-functionalized polyurethanes. In these embodiments, TAC⁺ compounds with diol R′ groups may be used as building blocks for polymer precipitates, crosslinked polymer beads, or high surface area polymeric foams using conventional synthetic methodologies.

A wide variety of CPI-functionalized materials can be made using polymers and polymer networks with these pendent groups. In some embodiments, the polymers can be multi-functional polymers for capturing CO₂ and either transforming the CO₂ into new chemicals or releasing it through external stimuli. Copolymerization of the building blocks (e.g., monomers or oligomers) with other functional monomers can be used to tune both CO₂ uptake and processability of the final polymers. Various macromolecular architectural considerations may also be used for tuning these properties. Examples of polymer architectures may include linear, branched, dendritic, bottle brush, surface-grafted, etc. Techniques for automated polymerization, high-throughput characterization, predictive modeling, etc., may be employed to facilitate selection of material compositions. Through selection of monomers/oligomers used in these processes, both homogeneous and segmented morphologies can be generated, allowing control over air permeation, modulus, hydrophilic/hydrophobic balance, and other key structural features.

In some embodiments, the polymers with pendent CPIs can be processed in modular architectures such as particles, suspensions, membranes, gels, etc. TAC⁺/CPI monomers/small molecules and oligomers may also be used to functionalize materials such as these in some embodiments. For example, nano- or microparticles can be formed from polymers with CPI pendent groups and/or surface-functionalized with CPI molecules. CPI surfactants may be used as coatings as well. These materials can be used to sequester and upcycle CO₂.

Various types of apparatus may be used in mediating absorption for DAC. For example, CPI-polymer materials for CO₂ capture/transfer may be employed in a packed bead reactor, trayed adsorption column, spray tower, spray dryer, etc. (see below). Techniques for gas-liquid mass transfer known to those of ordinary skill may be employed, and parameters such as flow rates, temperatures, concentrations, residence times, packing or tray types, nozzle design, droplet size (in spray methods) can be tuned.

In a packed bead reactor, there can be an absorption column that uses polymeric micro- and/or nanoparticles as a CPI-functionalized solid support resin. The absorption column can be packed with CPI-functionalized particles, and a CO₂-containing gas phase (e.g., atmospheric gas) can be passed through the column until CO₂ breakthrough is observed. Following the CO₂ exposure, the column can be detached, regenerated, and the gas released by heating as discussed above. In some embodiments, CPI-functionalized particles are formed using CPI-styrene monomers behaving as surfactants. In these instances, polymerization with a core derived from a hydrophobic styrene and various concentrations of divinylbenzene (DVB), can generate highly crosslinked particles by mini-emulsion polymerization.

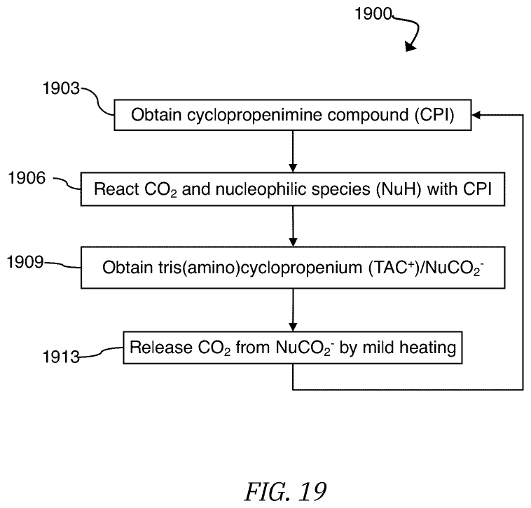

FIG. 19 is flowchart illustrating a process 1900 of reversible CO₂ capture, according to some embodiments. A CPI compound (e.g., any of the CPIs discussed above and/or illustrated in FIGS. 2A, 15, and 18A-18C) can be provided. This is illustrated at operation 1903. In some embodiments, the CPI compound is a pendent group or surface functionality on silica particles, solid polymer resin, etc. In further embodiments, the CPI compound is a small molecule, surface functionality, polymer pendent group, etc., used for DAC in an apparatus such as those discussed above. In other embodiments, which are not illustrated in FIG. 19, DBU may be provided rather than a CPI.

The CPI compound can then be reacted with CO₂ in the presence of water or another nucleophile NuH (see, e.g., FIGS. 3A-3D). This is illustrated at operation 1906. In some embodiments, the CO₂ is atmospheric CO₂, such as in embodiments involving DAC. However, the CO₂ may optionally be captured in a separate step and then mixed with the CPI compound. If DBU is used instead of CPI, the product can be DBU-H⁺/NuCO₂⁻ (see, e.g., FIG. 1B).

The product of the CPI/CO₂/NuH reaction can be obtained after operation 1906. This is illustrated at operation 1909. However, in other embodiments, process 1900 may begin at operation 1909. That is, a TAC⁺/NuCO₂⁻ (or DBU-H⁺/NuCO₂⁻) salt may be obtained from another reaction or source (not shown). For example, a TAC⁺/HCO₃⁻ salt may provided at operation 1909. The product obtained at operation 1909 can be heated to release the CO₂. This is illustrated at operation 1913. The temperature of heating can depend on the R and/or R′ groups of the TAC⁺ species, the type of material selected at operation 1903, e.g., DBU or CPI (solid or in solution), polymer resin, silica particles, etc., DAC techniques/apparatus employed, etc. In some embodiments, the temperature is above about 25-35° C. and below about 90-120° C. This is discussed in greater detail above.

In some embodiments, upon releasing CO₂ from NuCO₂⁻ and converting TAC⁺ back to CPI (or DBU-H⁺ back to DBU) at operation 1913, the resulting CPI or DBU is reused for at least one more cycle of process 1900. That is, process 1900 may proceed from 1913 back to operation 1903. In other embodiments, process 1900 can end operation 1913 without collecting and reusing the CPI or DBU.

Various embodiments of the present disclosure are described herein with reference to the related drawings, where like numbers refer to the same component. Alternative embodiments can be devised without departing from the scope of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus. Further, the word “providing” as used herein can refer to various actions such as creating, purchasing, obtaining, synthesizing, making available, etc. or combinations thereof.

As used herein, the articles “a” and “an” preceding an element or component are intended to be nonrestrictive regarding the number of instances (i.e., occurrences) of the element or component. Therefore, “a” or “an” should be read to include one or at least one, and the singular word form of the element or component also includes the plural unless the number is obviously meant to be singular. As used herein, the terms “invention” or “present invention” are non-limiting terms and not intended to refer to any single aspect of the particular invention but encompass all possible aspects as described in the specification and the claims.

Unless otherwise noted, ranges (e.g., time, concentration, temperature, etc.) indicated herein include both endpoints and all numbers between the endpoints. Unless specified otherwise, the use of a tilde (˜) or terms such as “about,” “substantially,” “approximately,” “slightly less than,” and variations thereof are intended to include the degree of error associated with measurement of the particular quantity based upon the equipment available at the time of filing the application. For example, “about” can include a range of ±8% or 5%, or 2% of a given value, range of values, or endpoints of one or more ranges of values. Unless otherwise indicated, the use of terms such as these in connection with a range applies to both ends of the range (e.g., “approximately 1 g-5 g” should be interpreted as “approximately 1 g-approximately 5 g”) and, in connection with a list of ranges, applies to each range in the list (e.g., “about 1 g-5 g, 5 g-10 g, etc.” should be interpreted as “about 1 g-about 5 g, about 5 g-about 10 g, etc.”).

As discussed above, CPIs and other compounds herein include R groups (e.g., R, R′, and R^{x}, where x is an integer), which can be any appropriate organic substituent known to persons of ordinary skill. In some embodiments, the R groups can include substituted or unsubstituted aliphatic groups. As used herein, the term “aliphatic” encompasses the terms alkyl, alkenyl, and alkynyl. As used herein, an “alkyl” group refers to a saturated aliphatic hydrocarbon group containing from 1 to 20 (e.g., 2 to 18, 2 to 8, 2 to 6, or 2 to 4) carbon atoms. An alkyl group can be straight, branched, cyclic, or any combination thereof. Examples of alkyl groups include, but are not limited to, methyl, ethyl, propyl, isopropyl, butyl, isobutyl, sec-butyl, tert-butyl, n-pentyl, n-heptyl, or 2-ethylhexyl. An alkyl group can be substituted with one or more substituents or can be multicyclic as set forth below. Unless specified otherwise, the term “alkyl,” as well as derivative terms such as “alkoxy” and “thioalkyl,” as used herein, include within their scope, straight chain, branched chain, and cyclic moieties.

As used herein, an “alkenyl” group refers to an aliphatic carbon group that contains from 2 to 20 (e.g., 2 to 18, 2 to 8, 2 to 6, or 2 to 4) carbon atoms and at least one double bond. Like an alkyl group, an alkenyl group can be straight, branched, or cyclic, or any combination thereof. Examples of an alkenyl group include, but are not limited to, allyl, isopropenyl, 2-butenyl, and 2-hexenyl. An alkenyl group can be substituted with one or more substituents as set forth below. As used herein, an “alkynyl” group refers to an aliphatic carbon group that contains from 2 to 20 (e.g., 2 to 18, 2 to 8, 2 to 6, or 2 to 4) carbon atoms and has at least one triple bond. Like an alkyl group, an alkynyl group can be straight, branched, or cyclic, or any combination thereof. Examples of an alkynyl group include, but are not limited to, propargyl and butynyl. An alkynyl group can be substituted with one or more substituents as set forth below.

The term “alkylthio” includes straight-chain alkylthio, branched-chain alkylthio, cycloalkylthio, cyclic alkylthio, heteroatom-unsubstituted alkylthio, heteroatom-substituted alkylthio, heteroatom-unsubstituted Cₙ-alkylthio, and heteroatom-substituted Cₙ-alkylthio. In some embodiments, lower alkylthios are contemplated. The term “haloalkyl” refers to alkyl groups substituted with from one up to the maximum possible number of halogen atoms. The terms “haloalkoxy” and “halothioalkyl” refer to alkoxy and thioalkyl groups substituted with from one up to five halogen atoms.

As described herein, compounds of the present disclosure can optionally be substituted with one or more substituents, such as are illustrated generally above, or as exemplified by particular classes, subclasses, and species of the present disclosure. Each substituent of a specific group may further be substituted with one to three of, for example, halogen, cyano, sulfonyl, sulfinyl, carbonyl, oxoalkoxy, hydroxy, amino, nitro, aryl, haloalkyl, and alkyl. For instance, an alkyl group can be substituted with alkyl sulfonyl and the alkyl sulfonyl can be optionally substituted with one to three of halogen, cyano, sulfonyl, sulfinyl, carbonyl, oxoalkoxy, hydroxy, amino, nitro, aryl, haloalkyl, and alkyl.

In general, the term “substituted” refers to the replacement of hydrogen radicals in a given structure with the radical of a specified substituent. Specific substituents are described above in the definitions and below in the description of compounds and examples thereof. Unless otherwise indicated, an optionally substituted group can have a substituent at each substitutable position of the group, and when more than one position in any given structure can be substituted with more than one substituent selected from a specified group, the substituent can be either the same or different at every position. A ring substituent, such as a hetero cycloalkyl, can be bound to another ring, such as a cycloalkyl, to form a spiro-bicyclic ring system, e.g., both rings share one common atom. As one of ordinary skill in the art will recognize, combinations of substituents envisioned by this present disclosure are those combinations that result in the formation of stable or chemically feasible compounds.

Modifications or derivatives of the disclosed compounds are contemplated as being useful with the methods and compositions of the present disclosure. Derivatives may be prepared and the properties of such derivatives may be assayed for their desired properties by any method known to those of skill in the art. In certain aspects, “derivative” refers to a chemically modified compound that still retains the desired effects of the compound prior to the chemical modification.

The descriptions of the various embodiments of the present disclosure have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A process, comprising:
providing a cyclopropenimine (CPI) having the following structure: 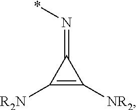
wherein each R is an organic substituent, and wherein the starred bond is to a carbon atom;
reacting the CPI with carbon dioxide (CO₂) in the presence of a nucleophilic species (NuH); and
releasing the CO₂ from a product of the reaction by heating the product to a temperature below approximately 120° C.

2. The process of claim 1, wherein the product has the following structure: 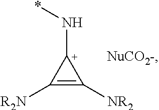
wherein Nu is a hydroxyl, primary amine, or secondary amine radical, the starred bond is to a carbon atom, and each R is an organic substituent.

3. The process of claim 1, wherein the CPI has a structure selected from the group consisting of:

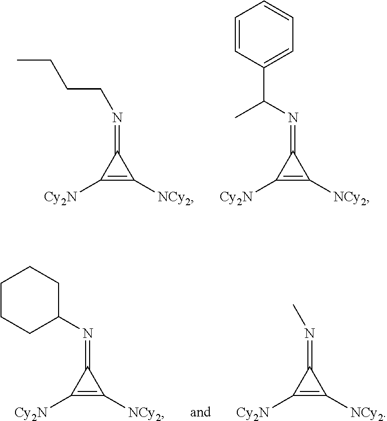

4. The process of claim 1, wherein the temperature is in a range selected from the group consisting of 30-50° C., 40-70° C., 50-80° C., 70-90° C., and 80-110° C.

5. The process of claim 1, wherein the CPI is a pendent group linked to a polymer backbone.

6. The process of claim 5, wherein the polymer is selected from the group consisting of polynorbornenes, polyurethanes, polymethacrylates, polymethylmethacrylates, polystyrenes, polyesters, polyamines, polyethers, epoxide resins, and polycarbonates.

7. The process of claim 5, wherein:
the nucleophilic species is a crosslinker (bis(NuH)); and
the product of the reaction is a gel.

8. The process of claim 1, wherein the CPI is a surface functionality on a silica material.

9. The process of claim 8, wherein the silica material is a mesoporous silica.

10. The process of claim 1, wherein the nucleophilic species NuH is selected from the group consisting of water, piperidine, aniline, and n-butylamine.

11. A process, comprising:
providing 1,8-diazabicyclo[5.4.0]undec-7-ene (DBU);
reacting the DBU with carbon dioxide (CO₂) in the presence of a nucleophilic species (NuH); and
releasing the CO₂ from a product of the reaction by heating the product to a temperature below approximately 120° C.

12. The process of claim 11, wherein the temperature is in a range selected from the group consisting of 30-50° C., 40-70° C., 50-80° C., 70-90° C., and 80-110° C.

13. The process of claim 11, wherein the nucleophilic species is selected from the group consisting of water, piperidine, aniline, and n-butylamine.

14. A process of direct air capture, comprising:
obtaining atmospheric carbon dioxide (CO₂);
reacting the CO₂ with an organic base comprising an imine moiety in the presence of a nucleophilic species (NuH);
obtaining a NuCO₂⁻ salt generated in the reacting; and
heating the NuCO₂⁻ salt to a temperature below about 120° C.

15. The process of claim 14, further comprising collecting CO₂ released by the heating.

16. The process of claim 14, wherein the organic base comprising the imine moiety is selected from the group consisting of a cyclopropenimine (CPI) and 1,8-diazabicyclo[5.4.0]undec-7-ene (DBU).

17. The process of claim 14, wherein the nucleophilic species comprises a moiety selected from the group consisting of a hydroxyl, a primary amine, and a secondary amine.

18. The process of claim 14, wherein the reacting comprises mixing a material containing the organic base with the CO₂.

19. The process of claim 18, wherein the material is selected from the group consisting of a solid-state cyclopropenimine (CPI), a CPI solution, a polymer with CPI pendent groups, and silica with CPI surface functionalities.

20. A composition for low-temperature release of carbon dioxide (CO₂), wherein:
the composition comprises a tris(amino)cyclopropenium (TAC⁺) salt having the following structure: 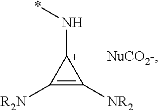
wherein:
Nu is a radical species selected from the group consisting of hydroxyl, a primary amine, and secondary amine;
the starred bond is to a carbon atom; and
each R is an organic substituent; and
the CO₂ is released at temperatures between about 30° C. and 120° C.

21. The composition of claim 20, wherein the release of the CO₂ generates a cyclopropenimine (CPI) having the following structure: 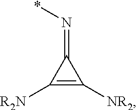
wherein each R is an organic substituent, and wherein the starred bond is to a carbon atom.

22. An apparatus, comprising:
a first component configured to provide a composition for capturing carbon dioxide (CO₂), wherein the composition includes a cyclopropenimine (CPI); and
a second component configured to release the CO₂ from a product of a reaction between the CPI, CO₂, and a nucleophilic species (NuH) by heating the product at a temperature below about 120° C.

23. The apparatus of claim 22, wherein the composition comprises a solid polymer resin.

24. The apparatus of claim 22, wherein the composition comprises mesoporous silica particles surface-functionalized with the CPI.

25. The apparatus of claim 22, wherein the CO₂ is captured from air.
